(19) United States
(12) Patent Application Publication
(10) Pub. No.: US 2024/0180269 A1
(43) Pub. Date: Jun. 6, 2024

(54) ARTICLE OF APPAREL INCLUDING GRASP-RESISTANT PANELS

(71) Applicant: Under Armour, Inc., Baltimore, MD (US)

(72) Inventors: James Carr, Baltimore, MD (US); Kyle Blakely, Baltimore, MD (US)

(21) Appl. No.: 18/443,824

(22) Filed: Feb. 16, 2024

Related U.S. Application Data
(63) Continuation of application No. 16/409,130, filed on May 10, 2019, now abandoned.
(63) Continuation-in-part of application No. 18/409,996, filed on Jan. 11, 2024.
Application No. 18/409,996 is a continuation of application No. 17/589,305, filed on Jan. 31, 2022, now Pat. No. 11,871,806.
Application No. 17/589,305 is a continuation of application No. 16/552,941, filed on Aug. 27, 2019, now Pat. No. 11,234,470.
Application No. 16/552,941 is a continuation of application No. 16/011,104, filed on Jun. 18, 2018, now Pat. No. 10,420,380.
Application No. 16/011,104 is a continuation of application No. 15/597,203, filed on May 17, 2017, now Pat. No. 10,010,118.
Application No. 15/597,203 is a continuation of application No. 14/597,051, filed on Jan. 14, 2015, now Pat. No. 9,655,389.
(60) Provisional application No. 62/669,477, filed on May 10, 2018.
(60) Provisional application No. 61/926,996, filed on Jan. 14, 2014.

(51) Int. Cl. A41D 1/04; B32B 5/02; B32B 5/26; D03D 1/00

(52) U.S. Cl. CPC A41D 1/04; B32B 5/024; B32B 5/026; B32B 5/26; D03D 1/00; A41D 2500/10; A41D 2500/20; A41D 2600/10; B32B 2437/00; D10B 2501/00

(57) ABSTRACT

An article of apparel with grasp-resistant panels includes a multilayer textile having a first textile and a second textile layer coupled to the first textile layer. The first textile layer possesses a first elongation value and the second textile layer possesses a second elongation value, the first elongation value being greater than the second elongation value. The second textile layer includes air vents integrally formed into the layer.

### CROSS REFERENCE TO RELATED APPLICATIONS

The present application is a continuation of U.S. patent application Ser. No. 16/409,130, filed May 10, 2019, entitled “Article of Apparel Including Grasp-Resistant Panels,” which is a nonprovisional application of U.S. 62/669,477, filed on 10 May 2018. This application is also a continuation-in-part of U.S. application Ser. No. 18/409,996, filed on Jan. 11, 2024 and entitled “Article of Apparel,” which is a continuation of U.S. application Ser. No. 17/589,305 filed on Jan. 31, 2022, now U.S. Pat. No. 11,871,806, which is a continuation of U.S. application Ser. No. 16/552,941 filed on Aug. 27, 2019, now U.S. Pat. No. 11,234,470 issued Feb. 1, 2022, which is a continuation of U.S. application Ser. No. 16/011,104 filed on Jun. 18, 2018, now U.S. Pat. No. 10,420,380 issued Sep 24, 2019, which is a continuation of U.S. application Ser. No. 15/597,203 filed on May 17, 2017, now U.S. Pat. No. 10,010,118 issued Jul. 3, 2018, which is a continuation of U.S. application Ser. No. 14/597,051 filed on Jan. 14, 2015, now U.S. Pat. No., 9,655,389 issued May 23, 2017, which claims priority to provisional application no. 61/926,996, filed Jan. 14, 2014 and entitled “Garment with Grasp-Resistant Panels.” The disclosure of each of the aforementioned applications is incorporated herein by reference in its entirety.

### FIELD OF THE INVENTION

The present invention relates to an article of apparel and, in particular, to an athletic garment including grasp-resistance features.

### BACKGROUND OF THE INVENTION

Athletic jerseys such as football or soccer jerseys, in order to accommodate wearers of various sizes, are loose fitting to allow the arms and body to move freely without undue resistance from the jersey. A loose-fitting jersey, however, exposes loose or hanging material that can be grabbed by an opponent during gameplay (e.g., for tackling). An athlete engaged in an athletic competition such as football or soccer seeks to minimize the opportunity for an opponent to hold onto the uniform in an effort to control the movement of the athlete. Conventional approaches included custom tailoring an ultra-tight-fitting jersey for each individual player and body type, which is time consuming and cost prohibitive.

Thus, it would be desirable to provide an article of apparel that permits wearing by multiple body types while inhibiting grasping by an opponent.

### BRIEF SUMMARY

An article of apparel includes grasp-resistant panels. Specifically, the article of apparel includes a composite textile including a first textile layer and a second textile layer. The first layer possesses a first degree of elongation. The second layer possesses a second degree of elongation that is less than the first degree of elongation. The second textile layer is discontinuous, being defined by a plurality of panels oriented in spaced relation along the first textile layer. In operation, the second textile layer limits/restricts the elongation of the first textile layer at each panel location, while expanding and contracting along non-paneled areas.

The second textile layer may further include an array of apertures oriented along a predetermined textile direction to provide mapped airflow/breathability to desired areas of the garment.

With this configuration, an article of apparel formed of the composite fits onto multiple body types, fits over safety equipment (shoulder pads, etc.), and permits body movement. Once on body, however, the article of apparel conforms closely to the wearer, impairing the ability of an opponent to grasp and hold the garment. In addition, the paneled areas provide improved airflow compared to similar composite textile structures lacking the apertures.

The above described features and advantages, as well as others, will become apparent to those of ordinary skill in the art by reference to the following detailed description and accompanying drawings. While it would be desirable to provide an article of apparel that provides one or more of these or other advantageous features, the teachings disclosed herein extend to those embodiments which fall within the scope of the appended claims, regardless of whether they include the foregoing features or accomplish one or more of the above-mentioned advantages.

### BRIEF DESCRIPTION OF THE SEVERAL VIEWS OF THE DRAWINGS

FIG. 1A is a front view in elevation of an article of apparel in accordance with an embodiment of the invention.

FIG. 1B is a rear view in elevation of the article of apparel shown in FIG. 1A.

FIG. 1C is a left side view in elevation of the article of apparel in FIG. 1A

FIG. 2 is a cross sectional view of a portion of the article of apparel, showing the multilayer fabric construction.

FIG. 3A illustrates a schematic of a woven textile forming a fabric structure for one or more bedding components of the bedding system of FIG. 1.

FIG. 3B illustrates a cross sectional view of the textile of FIG. 3A, taken along line 3B.

FIG. 3C illustrates the textile of FIG. 3A, showing dissolvable yarns within the structure.

FIG. 3D illustrates the textile of FIG. 3C, showing dissolved yarns and engineered apertures or air vents in the textile.

FIG. 4 illustrates a schematic of another woven textile in accordance with the invention, showing removal of a yarn from the structure and the formation of an aperture.

FIG. 5 is the second textile layer, showing the positioning of air vents along the textile structure.

FIG. 6 is a diagram showing the process of forming the article of apparel.

Like reference numerals have been used to identify like elements throughout this disclosure.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

### Multi-Layer Article of Apparel

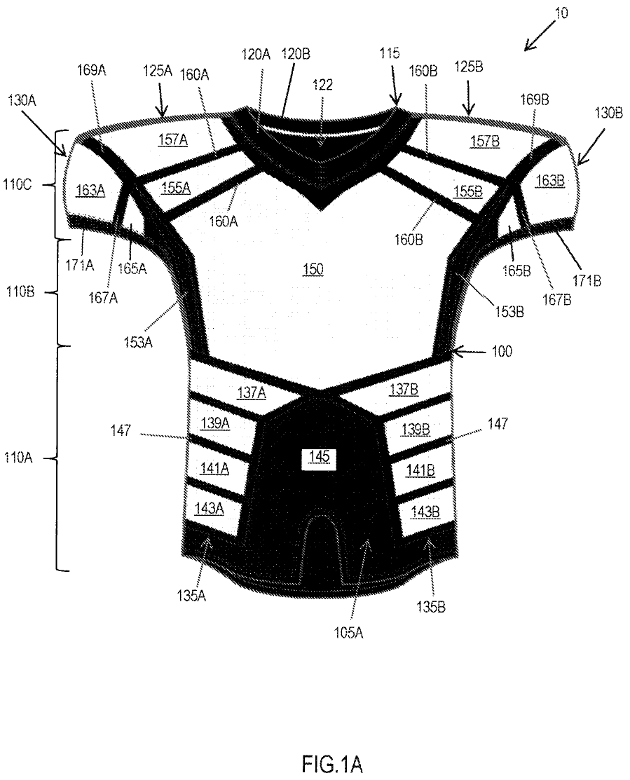

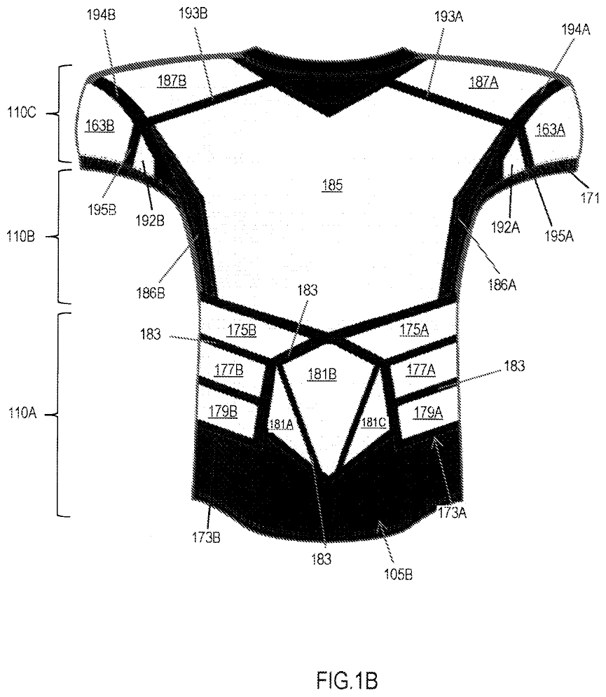

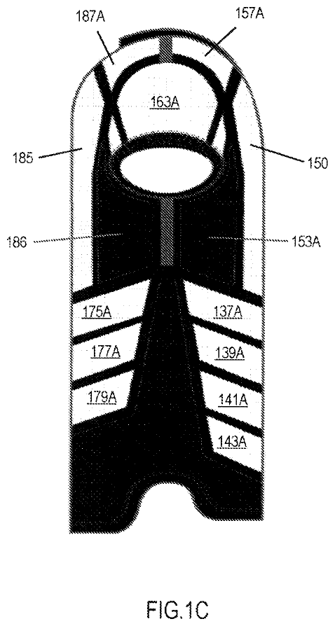

Referring to FIGS. 1A, 1B, and 1C, an article of apparel 10 may be in the form of a garment such as a game jersey and, in particular, an American football jersey or a global football jersey. As shown, the article of apparel 10 includes a body 100 with a front body portion 105A that generally covers the front of the torso and a rear body portion 105B that generally covers the rear of the torso. The body 100 defines a lower or waist section 110A, an intermediate or chest/back section 110B, and an upper or shoulder section 110C. The shoulder section 110C includes a collar 115 defining a forward neckline 120A and a rearward neckline 120B. The necklines 120A, 120B cooperate to define a neck opening 122. The shoulder section 110C further includes a first or right shoulder 125A extending laterally from the collar 115 and a first or right sleeve 130A extending from the right shoulder 125A, as well as a second or left shoulder 125B extending laterally from the collar 115 and a second or left sleeve 130B extending from the left shoulder 125B. The waist section 110A, which generally spans the waist of the wearer, includes a bottom opening 135.

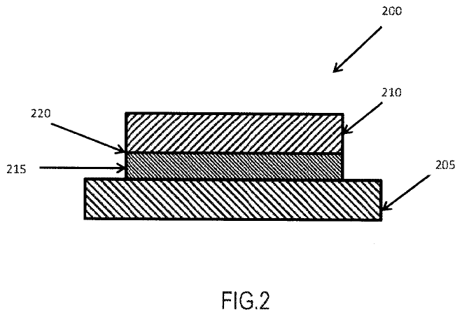

The article of apparel 10 is formed of a composite (multilayer) textile. Referring to FIG. 2, the composite textile 200 includes a first textile layer or substrate 205 coupled a second textile layer or overlay 210. The composite textile 200 is a fabric laminate, with the second textile layer 210 being mounted on (fixed or attached) to the first textile layer 205 via a bonding layer 215 (e.g., an adhesive film) to define a joint 220. In an embodiment, the first textile layer 205 is an inner layer (oriented closer to the user) of the fabric laminate 200 (thus the article of apparel 10), while the second textile layer 210 is an exterior layer (oriented further away from the wearer than the first layer). In another embodiment, the first textile layer 205 is the interior (innermost, user-facing) layer of the article of apparel 10, while the second textile layer 210 is the outermost layer.

### First Textile Layer

The first textile layer 205 possesses a first elongation value. Elongation is the deformation in the direction of load caused by a tensile force. Elongation may be measured in units of length (e.g., millimeters, inches, etc.) or may be calculated as a percentage of the original specimen length in its relaxed (unstretched) position. Typically, elongation is measured at a specified load such as the breaking load. In an embodiment, the first textile layer is a stretch or elastic fabric. Elastic or stretch fabrics are fabrics capable of expanding under load and regain their original form when the load is removed (a property called recovery). Elastic and stretch fabrics are typically made from an elastomer (i.e., fibers, filaments or yarn including an elastomer), either alone or in combination with other (non-elastomer) fibers, filaments, or yarns. Elastomers include, but are not limited to, rubber, polybutadiene, thermoplastic polyurethane, polyester-polyurethane copolymers (spandex/elastane), a biconstituent filament (elasterell), an elastoester, lastol, and polyisoprene (elastodiene).

Within the textile structure, the elastomeric fibers or yarns may be combined with relatively inelastic fibers or yarns. Inelastic fibers (called hard fibers or yarn) include polyester, cotton, nylon, rayon or wool. In an embodiment, the proportion of elastomeric fibers in the fabric may include about 20% by weight or less (e.g., from about 1% to about 20% by weight) to provide desired stretch and recovery properties of the fabric. In another embodiment, the elastomer fibers are present in an amount greater than 20%. By way of example, the first textile layer 205 includes a blend of polyester, nylon, and elastane (e.g., 40-55 wt % polyester; 30-35 wt % nylon, and 10-20 wt % elastane).

The elastic or stretch fabric may be configured as a comfort stretch or power stretch fabric. Comfort stretch fabrics generate an elongation of less than 30% (e.g., about 5%-30%) under load. Stated another way, comfort stretch fabric is a term that applies to fabrics with less than 30% stretch factors. Power stretch fabrics generate an elongation of about 30%-50%. Accordingly, power stretch fabrics have a higher degree of extensibility, as well as quick recovery. Stretch factors generally range from 30% to 50% and with no more than 5% to 6% loss in recovery. In still other embodiments, the first textile layer 205 may be a fabric having or over 100% stretch factors (elongation).

The elastic or stretch fabric (i.e., the first textile layer 205) may be a mono-elastic fabric, which stretches in a single, longitudinal or horizontal direction (also called a two-way stretch fabric) or bi-elastic fabric, which stretch in both longitudinal and horizontal directions (also called a four-way stretch fabric).

The first textile layer 205 is preferably a knit fabric. Knit fabrics include interlocking looped stitches, with the interlocking loops of yarn creating lengthwise ribs called wales and crosswise lines called courses. In single knits, the wales are visible from the right side of the fabric and the courses are visible on the fabric's wrong side. Knitting can further be used to provide elongation properties to the first textile layer. Knit fabrics are typically classified by their amount of stretch. Firm, stable knits have very little stretch. Moderate stretch knits are those that stretch about 25% in the crosswise direction. Two-way stretch knits may have up to 50% and 75% stretch in the lengthwise and crosswise directions. Super stretch knits stretch 100% or more in both directions.

For improved adhesion of the first textile layer 205 to the second textile layer 210, the first layer 205 is preferably seamless and/or stitchless either in its entirety or at least along the joint 220. In an embodiment, the entire first textile layer 205 (and thus the entire body 100) is seamless and stitchless. A first layer 205 with seams (i.e., apparel including joined fabric segments connected via stitches or thermal tapes) suffers from several disadvantages. First, seams are heavy relative to the fabric segments that the seams connect. Consequently, seams add to the weight to the article of apparel 10. Second, seams define the weakest point of an article of apparel—garment failure regularly occurs along the seam. Third, seams create friction points with respect to the wearer, making the garment less comfortable. Finally, as mentioned above, seams are poor direct bonding sites, preventing proper bonding of the second layer 210 to the first layer 205 (e.g., via an adhesive).

In an embodiment, the first textile layer 205 (the body 100) is formed via a seamless warp knit process (also referred to as warp knit seamless), which is capable of forming an article of apparel 10 with multiple diameters. Seamless warp knitting, for example, is based on double needle bar raschel knitting in which a yarn is knitted across adjacent columns (wales), rather than a single row. In contrast, circular knitting knits yarn along a single row, which results in fabric that is tube-shaped, possessing a single, consistent diameter. Thus, to form a sleeved shirt via circular knitting, it is necessary to form each of the trunk, shoulders, and sleeves separately, and then connect (via sewing or thermal tape) the pieces together. In contrast, seamless warp knitting is capable of forming the trunk, the arms, and the neck of a shirt during the same knitting run (no cutting and connection required, i.e., a unitary structure is formed). Circular knit fabrics, moreover, are prone to runs when the fabric is perforated. That is, should the fabric be perforated at a point, stitches proximate the point will unravel, creating a run/tear in the fabric. Warp knitted fabrics, however, will not run. Thus, warp knitting results in fabric having increased durability and strength.

Forming the first textile layer 205 (the apparel body 100) via seamless warp knitting, then, provides several advantages over garments formed via other knitting processes (e.g., circular knitting). With stretch garments, seams define areas of lower elongation (relative to the elongation of the fabric) within a garment. That is, a piece of seamless fabric will stretch more than a similar fabric piece with one or more seams. This lower elongation not only interferes with the wearer's freedom of movement, but limits the degree of adaptability of the fabric, limiting the body types on which the fabric may fit. A seamless garment, however, provides improved freedom of movement compared to the same garment formed with seams. This higher elongation further enables a wider fit range for various body shapes. That is, a single garment measurement can be suitable for wider range of fit because of its higher elasticity. Finally, the warp knit seamless process permits body mapping, where varying structures and/or yarn types can be integrated into garments and positioned accurately to impart special properties such as moisture management, heat management and compression.

Regardless of the knit process utilized (seamless, non-seamless, circular, etc.), the knit structure is configured for stretch and breathability. The knit structure, in contrast with woven structures, are generally open structures, permitting the passage of air therethrough via the knit pattern. Stated another way, knit structures, while continuous, include pores that permit fluid passage.

### Second Textile Layer

The second textile layer 210 possesses a second elongation value that is less than the first elongation value possessed by the first textile layer 205. By way of example, the second textile layer 210 is formed of non-stretch or no-stretch fabric, i.e., fabric having an elongation of about 5% or less (e.g., 0% elongation). In an embodiment, a non-stretch fabric includes yarns which have no more than 10% elongation. By way of example, the fabrics can be made from fibers including, but not limited to, polyester, polyamide, aramids, cotton, rayon, silk, polylactide- based fibers, wool, etc.

In accordance with embodiments of the invention, the textile forming the second layer 210 includes an array of apertures or openings formed integrally into the textile structure, the apertures permitting fluid flow (e.g., airflow) through the structure. Preferably, the textile forming the second layer is a woven textile. In weaving, two or more yarns are interlaced so that the yarns they cross each other at substantially right angles to produce woven fabric. The warp yarns (ends) run lengthwise (longitudinally) in the fabric, while the weft yarns (filling threads or picks) run from side to side (transversely) in the fabric. The set of lengthwise yarns or threads (called the warp) are interlaced with a set of crossing threads (called the weft) via a loom. Several types of weaving patterns may be utilized to form the textile structure. In plain weaving, the warp and weft are aligned to form a simple crisscross pattern. Specifically, each weft thread crosses the warp threads, with a first warp thread alternately going over one warp thread and under the adjacent warp thread. The adjacent weft thread inverts this process, with the weft thread crossing under the warp thread the previous thread crossed over. A basket weave, like the plain weave, includes two or more warp and filling threads woven side by side to resemble a plaited basket. In a satin weave, the face of the fabric consists almost completely of warp or filling floats produced in the repeat of the weave. A twill weave is characterized by diagonal lines produced by a series of floats staggered in the warp direction. A double weave includes two systems of warp or filling threads combined such that only one is visible on either side. A leno weave includes warp yarns arranged in pairs, with one warp yarn twisted around another warp yarn between picks of filling yarn.

In an embodiment, the textile structure forming the second layer 210 possesses a woven structure including by a plurality of weft runs or yarns and a plurality of warp runs or yarns. To form apertures, after formation of the woven textile, selected warp runs and/or weft runs (the yarns forming the run) are removed to create warp channels and weft channels, respectively. As a result, a warp channel is created between the adjacent, remaining warp runs (separating the warp yarns in the textile) and, similarly, a weft channel is created between the adjacent, remaining weft runs (separating the weft yarns in the textile).

Because of the channels, the textile structure includes areas having both warp and weft yarns, areas having only one of warp or weft yarns, and areas having neither warp nor weft yarns. An area lacking one or both warp yarns and weft yarns (i.e., areas from which the warp or weft yarn has been removed) includes openings or apertures in the woven structure that function as air vents, improving the air permeability and/or the breathability of the woven textile.

The warp and/or weft yarn may be removed in a non-mechanical manner. In an embodiment, the yarns are removed chemically, e.g., via dissolution in a solvent. Typically, the entire warp and or weft yarn is removed such that the channel extends the entire length and or width of the textile structure. This process and the resulting aperture structure may be distinguished from other, conventional aperture-forming processes. For example, the aperture formation process of embodiments of the invention may be distinguished from mechanical processes that form a discrete opening in a fabric, e.g., by means such as punching or cutting. The opening may further be distinguished from openings existing as a result of the textile formation process (e.g., a weaving or knitting process) where the opening results from the stitch pattern and not from processing after the formation of the textile (e.g. a knit mesh fabric).

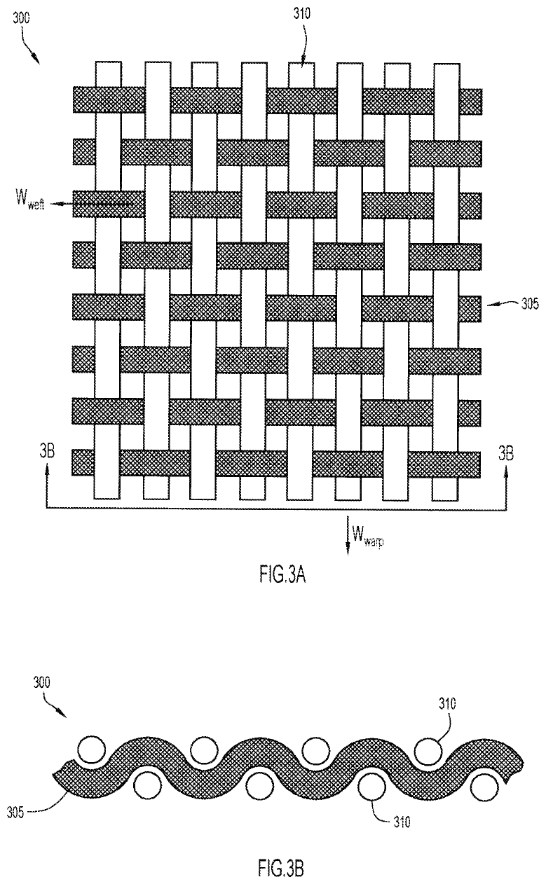

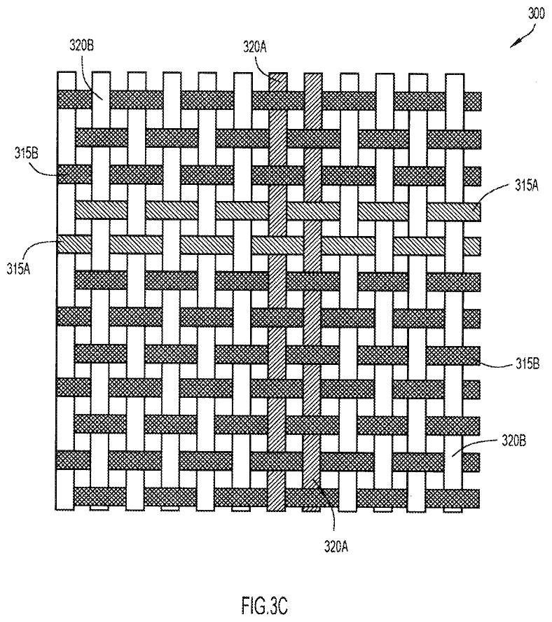

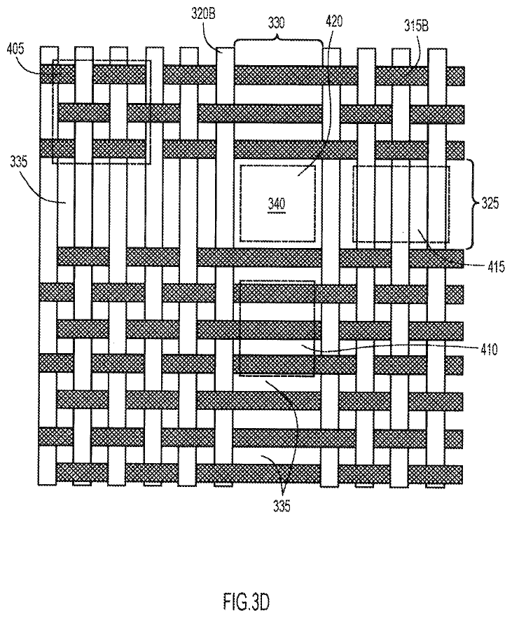

Referring to FIGS. 3A-3D, the woven textile structure 300 of the second layer 210 (one or more panels of the second layer) includes a plurality of weft yarns 305 (aligned in the direction W_{WEFT}as shown in FIG. 3A) interwoven with a plurality of warp yarns 310 (aligned in the direction W_{WARP}as shown in FIG. 3A) such that the warp and weft yarns cross at substantially right angles to each other. As best seen in FIG. 3C, the plurality of weft yarns 305 includes dissolvable yarns 315A and inert yarns 315B. Similarly, the plurality of warp yarns 310 includes both dissolvable yarns 320A and inert yarns 320B.

The dissolvable yarn can be formed from one or more filaments that are water soluble, such as polyvinyl alcohol (PVA) or a modified, water-soluble polyester. Other types of dissolvable yarns can also be utilized including, without limitation, cellulose fibers or filaments (e.g., rayon, lyocell, and cotton) or a polyamide fiber or filament (e.g., 6,6-nylon) that are dissolvable in a solvent including aluminum sulfate or acid sodium sulfate, or a modified polyester fiber or filament that is dissolvable in a solvent including sodium hydroxide. The inert or non-dissolvable yarn is formed of filaments or fibers that do not dissolve in the solvent that is used to dissolve the removable yarns. In an example embodiment, the two types of yarns used for forming textile structures for the panels of the second layer include inert/non-removable yarns formed from a non-dissolvable polyester material and dissolvable/removable yarns formed from a dissolvable polyester material (i.e., a modified polyester material that differs from the polyester material used to form the non-removable yarns) that dissolves in an aqueous solvent (e.g., water).

After the formation of the textile structure 300, the dissolvable yarns 315A, 320A and inert yarns 315B, 320B are exposed to a suitable solvent or dissolving agent. The dissolving agent may be applied via any process suitable for its described purpose (i.e., to apply the agent such that it contacts the entire textile and forces dissolvable yarns 315A, 315B into contact with the dissolving agent) including, without limitation, spraying the dissolving agent onto the textile structure, drawing the textile structure through a solution or bath containing the dissolving agent, etc. After exposure of the textile structure 300 to the dissolving agent (as shown in FIG. 3D), the inert yarns 315B, 320B remain intact, while the dissolvable yarns 315A, 320A dissolve in the dissolving agent (i.e., the yarns fall into solution with the solvent). This results in the selected yarns (i.e., the dissolvable yarns 315A, 320A) being removed from the textile structure 300 while leaving an elongated weft channel or gap 325 and an elongated warp channel or gap 330 where the yarns 315A, 320A previously existed. The channels 325, 330 form the apertures for the textile structure 300 which function as the air vents. As illustrated, the entirety of the warp and/or weft warn is removed from the textile structure 300.

The ratio of inert yarns to dissolvable yarns may be any suitable for its intended purpose (to create a textile structure). In an embodiment, the ratio of inert yarns to dissolvable yarns is from approximately 10:1 to approximately 7:3. Stated another way, the structure may include 10% to 50% dissolvable yarns (e.g., 20% to 40% or, by way of further example, approximately 33%). Structures with over 50% dissolvable yarns begin to weaken the textile. The arrangement of the yarns within the structure may also be selected to provide the desired level of breathability and strength in the textile. In each of the warp direction and weft direction, the textile structure may include a plurality of dissolvable yarns positioned between a first and second pluralities of inert yarns, the first and second pluralities being adjacent the plurality of dissolvable yarns.

The resulting textile structure includes areas of differing yarn combinations. Specifically, it includes a first area or portion 405 including both warp and weft yarns (both warp and weft runs), a second area or portion 410 including only warp yarns (i.e., where all the weft yarns are removed), and third area or portion 415 including only weft yarns (i.e., where all the warp yarns are removed), and a fourth area or portion 420 including no yarns (i.e., no warp or weft yarns). With this configuration an array of openings is formed including rows of apertures oriented along lines running orthogonal to each other (i.e., a grid pattern of apertures is formed). In addition, as shown in FIG. 3D, two types of apertures are formed: a first or small aperture 335 possessing a first dimension or diameter and a second or larger aperture 340 possessing a second dimension or diameter, the second dimension being greater than the first dimension. In general, the small apertures 335 exist along those areas 410, 415 where only the weft yarn 305 or warp yarn 310 is removed. The large aperture 340 exists at the intersection of the warp channel and the weft channel (i.e., the area 420 where the weft 305 and warp 310 yarns are removed).

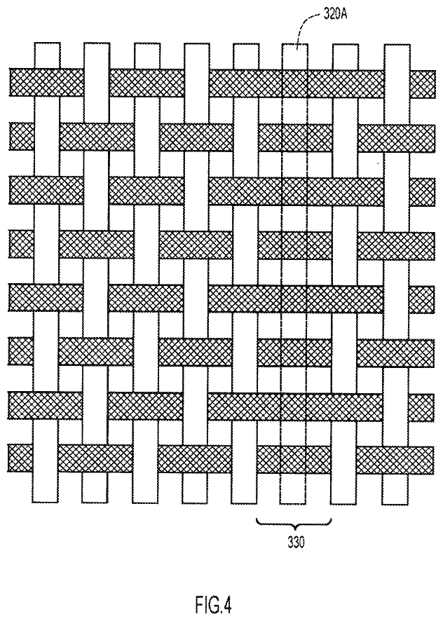

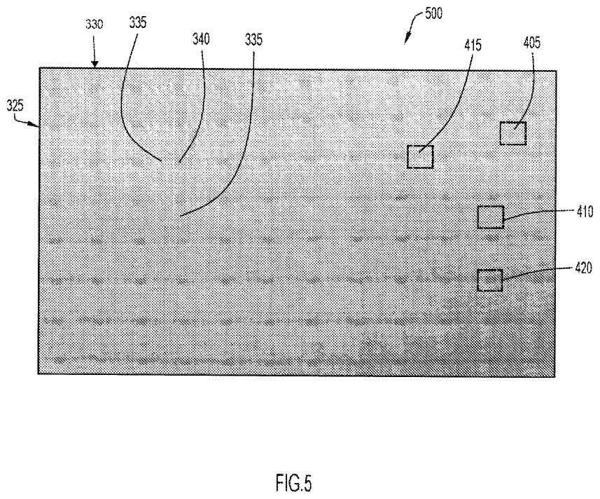

Thus, the embodiment depicted in FIGS. 3A - 3D describes an embodiment in which apertures of varying sizes can be selectively placed at desired locations of the textile structure 300 based upon the placement of dissolvable/removable yarns 315A and inert/non-removable yarns 315B within the textile structure. Depending upon the orientation or placement of different yarns at selected locations of a textile structure, engineered apertures can be formed of varying sizes (e.g., one or more sizes), varying shapes (e.g., one or more different shapes, including polygon such as rectangular or square, round, oval, irregular shaped, etc.). For example, in another embodiment depicted in FIG. 4, either weft yarns or warp yarns may be removed from the textile structure (instead of both warp and weft yarns being removed as depicted in FIGS. 1A-1D). In particular, a dissolved warp yarn 320A (shown in phantom) is illustrated in FIG. 4, which results in the formation of apertures having the same or similar shapes and dimensions along the warp direction of the textile structure. Other embodiments are also possible, including warp and weft yarns with different combinations of dissolvable and non-dissolvable yarns (e.g., any number of dissolvable warp or weft yarns provided in succession and adjacent to each other and separated by any number of non-dissolvable warp or weft yarns in succession).

Depending upon the placement and grouping of different warp and weft yarns that are dissolvable/removable and non-dissolvable/non-removable, the formation of apertures form air vents defined by the gaps formed by dissolved yarns from the textile structure. Thus, air vents can be formed or defined in any arrangement, shapes, sizes and/or patterns in a bedding component utilizing the techniques for forming engineered apertures as described herein. For example, air vents/engineered apertures can be formed having sizes ranging from a dimension (e.g., length and/or width dimension, or a diameter) that is 10 mm (millimeters) or less, such as 5 mm or less, or 1 mm or less, or even 0.10 mm or less. In some embodiments, small air vents can be formed having a dimension that is 0.10 mm or less, while larger apertures can also be formed having a diameter greater than 0.10 mm (e.g., 0.20 to 5 mm or greater).

In certain embodiments, the air vents are formed by completely dissolving and removing one or more warp and/or weft yarns to create air vents defined along in a linear direction at which the warp and/or weft yarn(s) were located prior to being completely dissolved and removed from the bedding component. For example, air vents can be formed along the entire linear dimension of a bedding component (e.g., along the entire length and/or entire width of the bedding component), where rows and/or columns of air vents can be defined (e.g., in a crossing pattern or array) along a surface and/or through a panel.

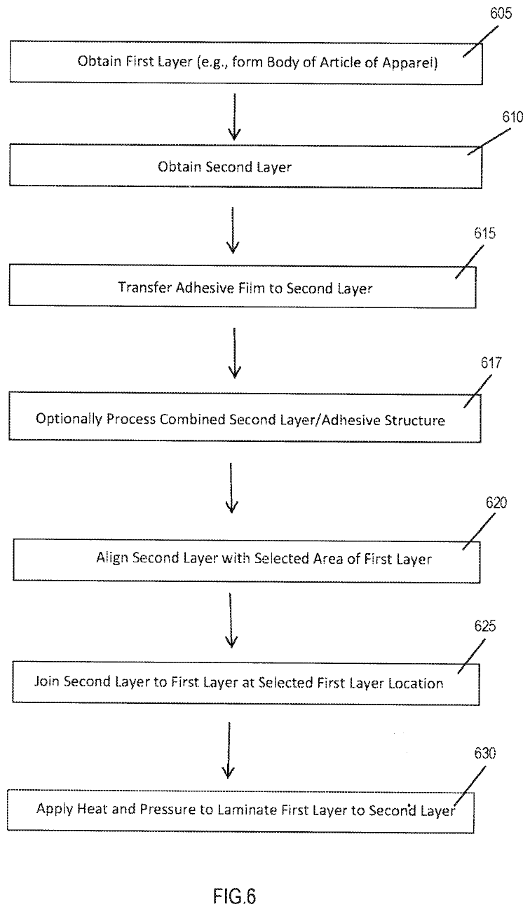

Referring to FIG. 5, the resulting textile structure 300 includes a sheet or panel 500 with weft channels 325 and warp channels 330 formed by removal of the corresponding plurality yarns as described above. The large apertures 420 are disposed at the intersection between weft channels or gaps 325 and warp channels or gaps 330. The areas 410, 415 of the channels 325, 330 between the large apertures 340 include the smaller apertures 335 formed by the spacing between adjacent yarns. Finally, areas or portions 405 containing both weft yarns and warp yarns do not contain apertures or opening as defined herein.

Stated another way, along the longitudinal axis of the weft channel 325 (where the weft yarn is removed) is the first area 410 in which warp yarns intersect and span the weft channel (e.g., intersecting the channel at approximately 90 degrees). This area includes the smaller apertures 335. In addition, the weft channel 325 includes the fourth area 420 where no warp yarn intersects the weft channel (i.e., neither warp nor weft yarns are present in the fourth area). This fourth area 420 defines the large aperture 340. Similarly, along the longitudinal axis of the warp channel 330 (where the warp yarn is removed) is the third area 415 in which weft yarns intersect and span the warp channel (intersecting the warp channel at, e.g., approximately 90 degrees). This area includes the smaller apertures 335. In addition, the warp channel 330 includes the fourth area 420 in which no weft yarn intersects the warp channel (i.e., neither warp nor weft yarns are present in the fourth area). Areas outside of the channels 325, 330 include both warp and weft yarns that are interlocked with each other at selected points along their respective lengths.

With the above construction, a grasp-resistant panel having a woven construction functions to resist gripping during gameplay while permitting fluid exchange (air and/or water) between the user and the surrounding environment, helping to regulate the temperature of the wearer during athletic activities. Conventional woven textiles, while strong and durable, are dense and tight and therefore have poor breathability and/ poor air permeability. Breathability is the ability of a fabric to allow moisture vapor to pass through it. Air permeability, in contrast, relates to the porosity or the ease with which air passes through the textile. Both air permeability and breathability influence the comfort, warmth, or coolness of a fabric. For sports jerseys, this can affect the level of comfort experienced by a user. Incorporating apertures or openings (air vents) into the panels cooperate with the breathable structure of the knitted first layer 205 to facilitate breathability, permeability and/or temperature regulation to enable the user's body to be at an appropriate temperature during gameplay. The textile structure, moreover, permits formation of air vents integrated into a single layer panel without damaging the integrity of the textile structure (which occurs during punching).

### Bonding Layer

The second layer 210 may be bonded or attached (e.g., directly bonded/attached) to the first layer 205 via a bonding layer 215. The bonding layer 215 may be an adhesive such as a thermoplastic adhesive. By way of example, the bonding layer 215 includes an adhesive film having a line temperature range of 150° C. to 170° C. and/or a softening point of 115° C. and/or a melt flow index of 34 dg/min. The thickness of the film may range from about 25 μm to about 100 μm. By way of specific example, the adhesive film is polyurethane adhesive film. The adhesive film may exhibit a recovery (the percent of the shape retained after being stretched to 100% of its original length) of approximately 90%. Such films are available under the trade name SEWFREE films, and are available from Bemis Associates, Shirley, MA.

The adhesive film may further include a thermoplastic polyurethane (TPU) film. TPU films exhibit high tensile strength, flexibility, and abrasion resistance. These films can be used with a variety of manufacturing methods ranging from hot-melt to flame lamination. Many different welding operations including ultrasonic, HF, RF and platen sealing can be used to activate the films. These films are commercially available from Bemis Associates, Shirley, MA (e.g., 3412 adhesive).

### Garment Structure

With the above-described configuration, a multilayer (composite) textile 200 (and thus the article of apparel 10) is provided stretch properties (e.g., overall stretch pattern) that can be tuned for a particular garment and use. The second textile layer 210, having a lower elongation than the first textile layer 205, restricts the elongation and/or movement of the first textile layer along the area of connection, i.e., along the joint 220 between the first 205 and second 210 layers (discussed in greater detail below). That is, along the joint 220, the elongation value of the first textile layer 205 is limited to the elongation value of the second textile layer 210 (e.g., less than 5% or 0%).

In addition, a second layer 210 provided by a woven textile structure with a plurality of apertures increases the breathability and air permeability of the article of apparel 10 relative to the same woven textile lacking the apertures. Accordingly, the knitting process forms a highly breathable fabric. As noted above, woven textiles, while strong and durable, are typically dense and tight. Consequently, woven textiles typically have poor breathability and/poor air permeability. Breathability relates to the ability of a fabric to allow moisture vapor to pass through it. Air permeability, in contrast, relates to the porosity or the ease with which air passes through the textile. Both air permeability and breathability influence the comfort, warmth, or coolness of a fabric.

Referring back the FIGS. 1A-1C, the first layer 205 is generally continuous, forming the body 100 of article of apparel 10. The second layer 210 is discontinuous, being defined by a plurality of plates or panels disposed at selected locations along the exterior surface of the first textile layer. Each panel may possess any dimensions (size/shape) suitable for its described purpose (to create no stretch, non-grasp zones). The panels of the second layer 210 may be oriented so that they register with specified areas of the body, i.e., areas subject to grab during game play including, but not limited to, the chest, shoulders, back, and stomach. The waist section 110A along the body front 105A includes a first lateral panel set 135A and a second lateral panel set 135B that cooperate to form pairs of stomach panels. Specifically, the waist section 110B includes a first panel pair 137A, 137B; a second panel pair 139A, 139B; a third panel pair 141A, 141B; and a fourth panel pair 143A, 143B disposed along the lateral sides of the wearer's stomach. Each pair is oriented in spaced relation to define not only a primary exposed area 145 or gap proximate the center of the stomach, but also secondary exposed areas 147 between the panels.

The chest section 110B of the front body portion 105A includes a single chest panel 150 spanning substantially the entire chest section, leaving lateral exposed areas or gaps 153A, 153B. Alternatively, the chest section 110B may include a plurality chest panels spaced about the chest section.

Each shoulder 125A, 125B of the shoulder section 110C includes a lower panel 155A, 155B spaced from an upper panel 157A, 157B to define exposed areas or gaps 160A, 160B within the shoulder section. Similarly, each sleeve 130A, 130B of the shoulder section 110C includes an upper panel 163A, 163B and a lower panel 165A, 165B spaced from not only each other, but also from the shoulder panels 163A, 163B, 165A, 165B to define exposed areas or gaps 167A, 167B, 169A, 169B. As shown, the shoulder sleeve panels 163A, 163B, 165A, 165B are also offset from the terminal end of each sleeve 130A, 130B to define exposed sleeve areas 171.

Referring to FIG. 1B, similar to the front body portion 105A, the waist section 110A of the rear body portion 105B includes lateral panel sets 173A, 173B defined by three pairs of lateral panels 175A, 175B, 177A, 177B, 179A, 179B; each pair being disposed on opposite lateral sides of the wearer's back. The waist section 110A further includes a plurality of central back panels 181A, 181B, 181C oriented to cover the small of the wearer's back. The panels 175A, 175B, 177A, 177B, 179A, 179B, 181A, 181B, 181C are spaced to define exposed areas or gaps 183.

The back section 110B of the rear body portion 105B includes a single panel 185 substantially covering the back to define lateral exposed areas or gaps 186A, 186B. Each shoulder 125A, 125B of the rear body portion 105B includes an associated rear shoulder panel 187A, 187B laterally spaced from sleeve panels 190A, 190B, 192A, 192B to define exposed areas 193, 194, 195 within the shoulder section 110C.

Accordingly, the second layer 210, being defined by a plurality of panels, is discontinuous. Thus, the second layer 210 does not completely cover the total surface area of the first layer 205, leaving selected areas of the first layer 205 exposed. The gap between adjacent panels may be aligned with flex points of the body (along joints, etc.) or along areas covering protective gear typically worn under game apparel (e.g., shoulder pads). As seen in the figures, a series of generally elongated vertical, horizontal, and angled exposed areas exists within the article of apparel 10. In these exposed (non-paneled) areas, the first layer 205 expands/stretches freely. The dimensions of the gap (in its resting (unstretched) state) may be any suitable for its described purpose. By way of example, the space between adjacent panels is less than twelve inches, e.g., less than six inches, less than four inches, or no more than two inches. Areas of greater than six inches create grab points on the garment. Spacing of less than 0.5 inches minimizes the adaptability of the apparel.

Where the exposed areas stretch freely, movement (stretching) of the first textile layer 205 is restricted (e.g., eliminated) wherever the first textile layer is connected to an associated panel of the second textile layer 210. That is, any portion of the first textile layer 205 aligned/in registry with the second textile layer 210 (i.e., aligned with a panel) will not be permitted to elongate/stretch (or will possess an elongation value equal to that of its associated second layer panel). With this configuration, the second layer panels will be able to move relative to each other (due to the resiliency of the exposed areas) but will be fixed relative to the first layer (along the joint 220). Accordingly, the multilayer apparel textile 200 expands and contracts along the exposed areas but does not expand along the panels.

In an embodiment, the second textile layer 205 covers at least 25% of the surface area of the exterior side of the first textile layer (leaving 75% of the first textile surface area exposed). In another embodiment, the second textile layer 210 covers at least 50% of the first textile layer surface (leaving 50% exposed). In still another embodiment, the second textile layer 210 covers at least 75% of the first textile layer surface (leaving 25% exposed). In still further embodiment, the second textile layer 210 covers at least 85% of the first textile layer surface (leaving 15% exposed).

### Method of Manufacturing the Article of Apparel

The process for forming the article of apparel 10 is explained with reference to FIG. 6. Initially, the first textile layer 205 is obtained (Step 605). As noted above, the number of seams within the first layer 205 should be minimized and, if possible, eliminated. By way of example, the first layer 205 may be formed via a seamless warp knitting process utilizing a jacquard apparatus (e.g., the SWD4/2J electronic warp knitting machine, available from Santoni, Brescia, Italy). It is important to note that, when the first textile layer 205 is warp knit seamless, the entire garment defined by the first layer (jersey or pants) is formed during the same knitting run (i.e., no further processing (sewing) is required to form the first layer 205).

Next, the second textile layer 210 is provided (Step 610). As explained above, in an embodiment, the second textile layer 210 is a woven non-stretch fabric including a core fabric with a crosshatch of reinforcing yarns. The second textile layer 210 is mounted onto the first textile layer 205 in an area of the first textile layer that is seamless and stitchless. Specifically, a polyurethane adhesive film on release paper (e.g., Bemis 3412) is brought into contact with a surface of the second textile layer 210 to adhere the film to the second textile layer 210 (Step 615). As explained above, once adhered, the second textile layer 210 may be processed. Specifically, the second textile layer 210 is divided/separated into individual panels via a cutting device such as a laser cutter. The panels may be circles, polygons, etc. Additionally, if ventilation holes are desired, the second layer 210 (and the adhesive film) may be perforated via, e.g., laser perforation, mechanical punching, etc. (step 617). Processing after application of the adhesive stabilizes the second layer fabric, minimizing fraying or runs along cuts and stabilizing the areas around perforation holes.

Once processed, the second textile layer 210 may be bonded to the first textile layer 205. The release paper is removed from the second textile layer, exposing the adhesive. The exposed adhesive side of second layer panel is then brought into registry (aligned) with a selected area of the first textile layer 205 (Step 620) and is urged into contact therewith (step 625). For example, the second layer panels may be aligned with one or more areas of the waist section 110A, chest/back section 110B, and shoulder section 110C. In an embodiment, a first panel is positioned on the first textile layer and a second panel is positioned adjacent the first panel such that the panels are spaced from each other. When multiple panels are provided, adjacent panels may be spaced apart from each other.

Heat and pressure is then applied to the layers 205, 210, 215 (Step 630), thereby bonding the first textile layer 205 to the second textile layer 210. For example, when a flat press is utilized, a lamination temperature of approximately 150° C.-170° C. is applied under a pressure of approximately 40-60 psi for approximately 5 to 30 seconds. If a continuous bonding machine is utilized, a temperature of 250° C. to 300° C. at a speed of 1.5 to 2.0 m/min under pressure of 1 Bar (14.3 psi) is effective.

If warp knit seamless was utilized to form the first textile layer 205, the article of apparel is formed upon bonding the desired second textile layer panels thereto. If, however, other methods were used to form the first textile layer 205, it is possible to shape the first textile layer fabric into the article of apparel (e.g., via sewing pieces together or other conventional methods) bonding of the second textile layer 210 thereto. Alternatively, the multilayer apparel textile 200 may be shaped into apparel after formation.

The resulting article of apparel 10 or garment possesses several functional advantages over conventional sporting garments. The exposed areas enable the overall expansion of the garment when a force is applied. That is, each exposed area expands from its normal position, permitting the garment to expand to accommodate placement on the body, as well as to accommodate and protective equipment such as shoulder pads. Additionally, each exposed area may expand/stretch to varying degrees to accommodate varying body types and types of protective equipment. Once on body, however, the garment 10 constricts, becoming snug against the user since the elastic/compression fabric is biased toward its normal position (i.e., toward the user). Consequently, the garment eliminates loose hanging fabric that could be grabbed by a competitor during game player. The areas of the article of apparel 10 including second layer panels do not stretch; moreover, the panels of the second textile layer 210 possess a low coefficient of friction (relative to the first textile layer). Consequently, it is difficult for a competitor to grasp the article of apparel 10 along a panel. That is, it will be difficult for a competitor to grasp a handful of fabric. Instead, the competitor's hands will slide off.

The above-described embodiment of the invention provides an article of apparel that, while inhibiting grasping by a competitor, will permit full range of motion during use. The skin of the body may expand as much as 50% during movement (elbow, knee, etc.). Consequently, elastic fabric is advantageous to accommodate for motion. The fabric laminate of the described embodiment of the present invention retains its elastic properties at critical movement points along the body, permitting a user to participate in the natural, full range of motion, which is beneficial in athletic activities. This is in contrast to jerseys formed solely of non-stretch material, which interfered with athlete movement, making it difficult too, e.g., run, pass, catch, and/or block.

While the invention has been described in detail and with reference to specific embodiments thereof, it will be apparent to one skilled in the art that various changes and modifications can be made therein without departing from the spirit and scope thereof. In other embodiments, the dissolving agent may be placed onto selected yarns to initiate dissolution of those yarns while leaving the others intact. For example, various printing processes may be used to selectively deposit the dissolving agent onto the textile yarns. Additionally, processes such as chemical vapor deposition may be utilized. Accordingly, only the yarns to be dissolved would be contacted by the dissolving agent. With this configuration, the entire textile may be formed of dissolvable yarns, with the yarns selectively dissolved by selective placement of the dissolving agent. The yarns may possess any dimensions (diameter/shape) suitable for its descried purpose. In an embodiment, the dernier of each of the warp and weft yarns are the same. Alternatively, the dernier of the warp yarn may be greater than the dernier of the weft yarn, or vice versa. By way of example the weft yarn may possess a larger dernier than the warp yarn.

While possible, the apertures in the woven structure are generally not formed via mechanical processes such as laser cutting, punching, etc., or via etching process involving an aperture mask.

The aperture dimensions (diameter and shape) may be any diameter suitable for its described purpose. The aperture dimensions may be selected by selecting yarns of a desired denier (the larger the denier, the larger the aperture). The aperture dimensions may be selected to impart air permeability or breathability, while being waterproof (e.g., apertures having a diameter of less than 100 μm), based on the fact that water droplets generally possess a diameter of 100 μm or more. In an embodiment, the apertures range in size from 4 μm to 1000 μm. In another embodiment, the apertures range in size from 1 mm to 5 mm. The ratio of the diameter of the small aperture to the large aperture may be 1:2. In other embodiments, the ratio of the diameter of the small aperture to the large aperture is approximately 1:1.5 to 1:5. The density of engineered apertures within the textile structure may be selected to provide the desired amount of air permeability and/or breathability. In an embodiment, the textile includes approximately 10 engineered apertures per square centimeter of textile surface.

The article of apparel includes garments such as headwear, outerwear (coats, jackets, and gloves), pants, shorts, shirts, socks, footwear, etc. In an embodiment, the article of apparel is a sporting jersey such as a football jersey, soccer jersey, rugby jersey, or basketball jersey. The jersey includes a torso portion, a first arm portion, and a second arm portion. The jersey may be a shirt, tank-top or other torso covering garment that is use in association with pants (e.g., shorts, long-pants, or other leg-covering garments) of similar construction, the pants including a waist portion, a first leg portion, and a second leg potion. The entire article of apparel may include the engineered apertures. For example, each pant leg of the pants, as well as the torso and arm portions may include the engineered apertures.

In addition to the foregoing, it will be recognized that various additional changes and modifications can be made to the embodiments disclosed herein without departing from the spirit and scope of the invention. For example, the first textile layer 205 may be engineered with vary degrees of stretch. By way of example, the arm sleeves of a shirt may possess an elongation of 50%, while the trunk of shirt may possess an elongation of less than 30%.

The second textile layer 210 may be formed of fabric having a low stretch (e.g., less than about 40% stretch, less than about 25% stretch, less than about 10% stretch, less than about 5% stretch, or less than about 3% stretch) or no stretch (approximately 0% stretch). The panels forming the second textile layer 210 may all be formed of the same or may be formed different materials. Additionally, the panels forming the second textile layer 210 may each possess the same stretch percentage or may possess different stretch percentages. For example, the chest panel may be formed of non-stretch material (material possessing a 0% stretch), while the shoulder panels may be formed of material possess low stretch (e.g., less than about 2% stretch).

Each panel may possess any dimensions (size/shape) suitable for its described purpose. By way of example, the panels may be polygons or circles. The panels, moreover, may be arranged in any pattern or collection of panels. The cells 315 of the second textile layer 210 may be any shape suitable for their described purpose. By way of example the cells may be polygonal, e.g., possessing a generally square shape. The amount of first textile layer surface area left covered and/or exposed may be any suitable for its described purpose. Generally, the higher the elasticity of the first layer 205, the greater the amount of surface area that may be covered. The second layer may be provided in the form of individual panels to which the adhesive is applied or may be provided as a single sheet that is cut into panels after application of the adhesive.

The first textile layer 205 may possess distinct and continuous elasticity. The percent elongation of the first layer may include, but is not limited to, greater than about 50% stretch/growth/expansion, greater than about 60% stretch/growth/expansion, greater than about 70% stretch/growth/expansion; greater than about 80% stretch/growth/expansion, greater than 90% stretch/growth/expansion, greater than about 100% stretch/growth/expansion, and greater than about 125% stretch/growth/expansion (all from a normal (unstressed) position).

In at least one embodiment, the first textile layer 205 possesses an elongation of about 5% or more (e.g., more than 5%) and the second textile layer 210 possesses an elongation of about 5% or less (e.g., less than 5%). In another embodiment, the first textile layer possesses an elongation of about 100% or more (e.g., at least 100%), while the second textile layer possesses an elongation of about 0% (e.g., 0%).

It is intended that the present invention covers the modifications and variations of this invention provided they come within the scope of the appended claims and their equivalents. It is to be understood that terms such as “top,” “bottom,” “front,” “rear,” “side,” “height,” “length,” “width,” “upper,” “lower,” “interior,” “exterior,” “medial,” “lateral,” and the like as may be used herein, merely describe points of reference and do not limit the present invention to any particular orientationor configuration.

What is claimed is:

1. An article of apparel comprising:
a continuous first textile layer possessing a first elongation value; and
a discontinuous second textile layer possessing a second elongation value lower than the first elongation value, the second textile layer comprising a woven textile including a plurality of warp yarns and a plurality of weft yarns, the second textile layer further including:
a first textile portion including both the plurality of warp yarns and the plurality weft yarns,
a second textile portion including only warp yarns and defining a warp channel including a plurality of warp apertures, and
a third textile portion including only weft yarns and defining a weft channel including a plurality of weft apertures.

2. The article of apparel according to claim 1, wherein the plurality of warp yarns and the plurality of weft yarns are inert yarns not dissolvable by a dissolving agent.

3. The article of apparel according to claim 2, wherein the woven textile further comprises a fourth textile portion including neither warp yarns nor weft yarns.

4. The article of apparel according to claim 3, wherein:
the second textile layer includes a first panel oriented in spaced relation from a second panel to define a gap between the first and second panels;
the first textile layer spans the gap; and
the gap defines a resilient expansion area within the article of apparel permitting movement of the first panel relative to the second panel.

5. The article of apparel according to claim 4, wherein the first textile layer is a continuous knit fabric extending under an entirety of the second textile layer.

6. The article of apparel according to claim 1 further comprising a bonding layer disposed between the first textile layer and the second textile layer, the bonding layer provided by an adhesive film connecting the second textile layer to the first textile layer.

7. The article of apparel according to claim 1, wherein:
the first textile layer possesses an elongation of greater than 5%; and
the second textile layer possesses an elongation of less than 5%.

8. The article of apparel according to claim 7, wherein the first textile layer possesses an elongation of about 100% or more.

9. The article of apparel according to claim 1, wherein the second textile layer comprises:
a first aperture possessing a first diameter of less than 100 μm; and
a second aperture possessing a second diameter, wherein the second diameter is greater than the first diameter.

10. The article of apparel according to claim 1, wherein the article of apparel is a jersey configured to be worn on a torso of a wearer.

11. An article of apparel to be worn by an athlete, the article of apparel comprising:
a first textile layer possessing a first elongation value; and
a second textile layer coupled to the first textile layer, the second textile layer possessing
a second elongation value, the first elongation value being greater than the second elongation value, wherein the second textile layer comprising a woven textile including:
a plurality of warp yarns and a plurality of weft yarns,
a warp channel separating a first warp yarn from a second warp yarn, the warp channel defining a plurality of warp apertures, and
a weft channel separating a first weft yarn from a second weft yarn, the weft channel defining a plurality of weft apertures.

12. The article of apparel according to claim 11, wherein the plurality of warp yarns and the plurality of weft yarns are inert yarns not dissolvable by a dissolving agent.

13. The article of apparel according to claim 11, wherein the woven textile further comprises a textile portion including neither warp yarns nor weft yarns.

14. The article of apparel according to claim 13, wherein:
the second textile layer includes a first panel oriented in spaced relation from a second panel to define a gap between the first and second panels;
the first textile layer spans the gap; and
the gap defines a resilient expansion area within the article of apparel permitting movement of the first panel relative to the second panel.

15. The article of apparel according to claim 11, wherein the first elongation value is greater than 5% and the second elongation value is less than 5%.

16. The article of apparel according to claim 15, wherein the first elongation value is about 100% or more.

17. The article of apparel of claim 11 wherein the plurality of warp apertures and the plurality of weft apertures possess a diameter between 4 μm and 1000 μm.

18. A method of forming an article of apparel, the method comprising:
obtaining a first textile having a first elongation value;
obtaining a second textile having a second elongation value that is less than the first elongation value, wherein:
the second textile comprises a woven textile having a plurality weft yarns and a plurality of warp yarns, and
the plurality of weft yarns includes a dissolvable weft yarn dissolvable by a dissolving agent and inert weft yarn not dissolvable by the dissolving agent;
dissolving the dissolvable weft yarn in the dissolving agent to form a weft channel, the weft channel being oriented between adjacent inert weft yarns; and
coupling the second textile to the first textile to form to article of apparel.

19. The method according to claim 18, wherein the plurality of warp yarns includes a dissolvable warp yarn dissolvable by a dissolving agent and inert warp yarn not dissolvable by a dissolving agent, the method further comprising dissolving the dissolvable warp to form a warp channel, the warp channel being oriented between adjacent inert warp yarns.

20. The method according to claim 19 further comprising dividing the second textile into a first panel and a second panel prior to coupling the second textile to the first textile.
